(19) United States
(12) Patent Application Publication
(10) Pub. No.: US 2016/0119769 A1
(43) Pub. Date: Apr. 28, 2016

(54) PROXIMITY SERVICE

(71) Applicant: TELEFONAKTIEBOLAGET L M ERICSSON (PUBL), Stockholm (SE)

(72) Inventors: Roland GUSTAFSSON, Bengtsfors (SE); Gunnar RYDNELL, Göteborg (SE); Stefan Karl TOTH, Göteborg (SE)

(21) Appl. No.: 14/895,328

(22) PCT Filed: May 21, 2014
(86) PCT No.: PCT/EP2014/060426

§ 371 Date: Dec. 2, 2015

Related U.S. Application Data
(60) Provisional application No. 61/844,043, filed on Jul. 9, 2013.

(51) Int. Cl. H04W 8/00; H04L 29/06; H04W 76/02

(52) U.S. Cl. CPC H04W 8/005; H04W 76/023; H04L 63/10

(57) ABSTRACT

The embodiments herein relate to a method in a first wireless device for enabling ProSe communication in a communications network. The first wireless device is in proximity of a second wireless device. The first wireless device, using at least one of an Application ID, ProSe ID, Application User ID and expression code, enables the first wireless device to discover the second wireless device and to be discoverable by the second wireless device. The first wireless device communicates directly with the second wireless device using a direct ProSe link.

### TECHNICAL FIELD

Embodiments herein relate generally to a first wireless device, a method in the first wireless device, a network node and a method in the network node. More particularly the embodiments herein relate to enabling Proximity Service (ProSe) communication in a communications network.

### BACKGROUND

In a typical communications system, a wireless device communicates via a Radio Access Network (RAN) to one or more Core Networks (CNs). The communications system may also be referred to as e.g. a wireless communications network, a wireless communications system, a communications network, a network or a system. In the following, the RAN may be referred to as a network or an operator network.

The wireless device may be a device by which a subscriber may access services offered by an operator's network and services outside the operator's network to which the operator's RAN and CN provide access, e.g. access to the Internet. The wireless device may be any device, mobile or stationary, enabled to communicate over a radio channel in the communications system, for instance but not limited to e.g. user equipment, mobile phone, smart phone, sensors, meters, vehicles, household appliances, medical appliances, media players, cameras, Machine to Machine (M2M) device, Device to Device (D2D) device, Internet of Things (IoT) device or any type of consumer electronic, for instance but not limited to television, radio, lighting arrangements, tablet computer, laptop or Personal Computer (PC). The wireless device may be portable, pocket storable, hand held, computer comprised, or vehicle mounted device, enabled to communicate voice and/or data, via the RAN, with another entity, such as another wireless device or a server.

The RAN covers a geographical area which is divided into cell areas. Each cell area is served by a base station. The base station sometimes may be referred to as e.g. Radio Base Station (RBS), evolved Node B (eNB), eNodeB, NodeB, B node, or Base Transceiver Station (BTS), depending on the technology and terminology used.

In previous technologies, when two wireless devices in close proximity communicated with each other, their data path (i.e. user plane) went via the operator network. The data path for this type of communication is exemplified in FIG. 1. In FIG. 1, a communications system 100 comprises a first wireless device 101a which communicates with a second wireless device 101b via their respective base station, i.e. a first base station 103a and a second base station 103b. Nodes comprised in the core network 105 are also involved in the communication between the two wireless devices 101.

When wireless devices are in proximity of each other, they may be able to use a “direct mode” or “locally-routed” path instead of communicating via the operator network. Such direct communication may be referred to as ProSe. ProSe may be applicable in both commercial/social use and in public safety in for example the case of lack of Evolved-Universal Terrestrial Radio Access Network (E-UTRAN) coverage, but also in the case when E-UTRAN coverage is available.

An example of a ProSe communications system 200 is exemplified in FIG. 2 where the first wireless device 101a and the second wireless device 101b communicates using a ProSe direct link 202, without going via the first base station 103a and the second base station 103b and the nodes in the core network 105. In some embodiments, the communication between the first wireless device 101a and the second wireless device 101b may be locally routed via the first base station 103a in the case that both wireless devices 103a, 103b are served by the first base station 103a.

There is ongoing work in Third Generation Partnership Project (3GPP) related to ProSe in order to be able to implement ProSe, and there is still a number of unsolved issues before ProSe may be implemented related to for example the ProSe system architecture, configuration for ProSe direct discovery, ProSe Direct Communication one-to-one and one-to-many, charging in ProSe, ProSe Identities, Authorization for ProSe capability feature etc.

### SUMMARY

An objective of embodiments herein is therefore to provide an improved ProSe communications system.

According to a first aspect of the embodiments herein, the objective is achieved by a method in a first wireless device for enabling ProSe communication in a communications network. The first wireless device is in proximity of a second wireless device. The first wireless device, using at least one of an Application ID, ProSe ID, Application User ID and expression code, enables the first wireless device to discover the second wireless device and to be discoverable by the second wireless device. The first wireless device communicates directly with the second wireless device using a direct ProSe link.

According to a second aspect of the embodiments herein, the objective is achieved by a method in a network node for enabling ProSe communication in a communications network. The network node, using at least one of an Application ID, ProSe ID, Application User ID and expression code, enables a first wireless device and a second wireless device to discover each other and to be discoverable by each other.

According to a third aspect of the embodiments herein, the objective is achieved by a first wireless device for enabling ProSe communication in a communications network. The first wireless device is in proximity of a second wireless device. The first wireless device is configured to, using at least one of an Application ID, ProSe ID, Application User ID and expression code, enable the first wireless device to discover the second wireless device and to be discoverable by the second wireless device. The first wireless device is configured to communicate directly with the second wireless device using a direct ProSe link.

According to a fourth aspect of the embodiments herein, the objective is achieved by a network node for enabling ProSe communication in a communications network. The network node is configured to, using at least one of an Application ID, ProSe ID, Application User ID and expression code, enable a first wireless device and a second wireless device to discover each other and to be discoverable by each other.

Thanks to the ProSe identities Application ID, ProSe ID, Application User ID and Expression Code, the methods for discovery in the communications system are made possible which also improves the ProSe communications system.

Embodiments herein afford many advantages, of which a non-exhaustive list of examples follows:

An advantage of the embodiments herein is that it may provide coverage for communication between wireless devices even in places where there is no 3GPP or Wireless Local Area Network (WLAN) coverage.

Another advantage of the embodiments herein is that the ProSe identities may enable the methods for efficient direct discovery and communication between wireless devices.

A further advantage of the embodiments herein is that they may provide increased income for the network operators by offering new ProSe services.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a schematic block diagram illustrating a communications system without implementing ProSe.

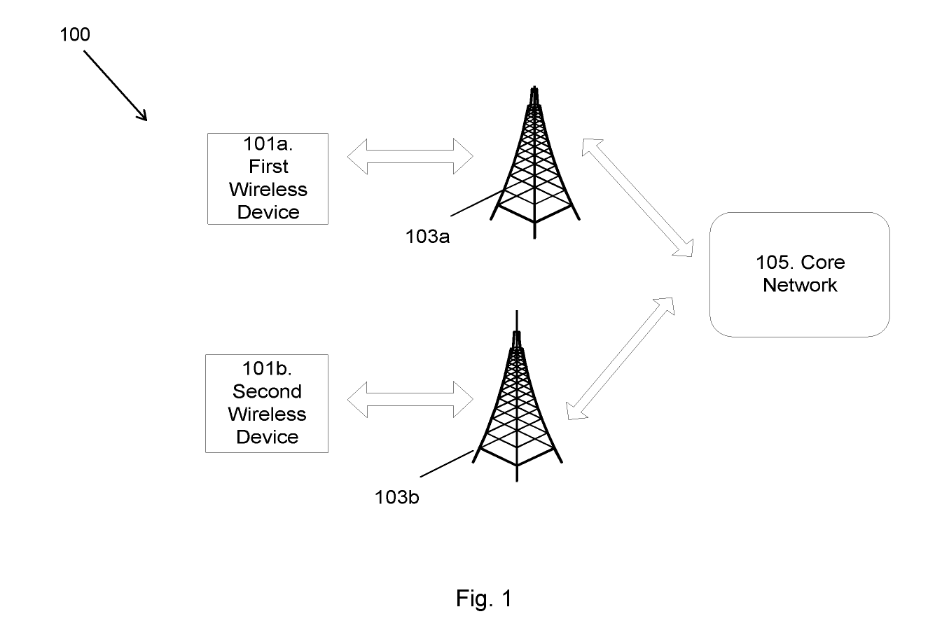

FIG. 2 is a schematic block diagram illustrating a communications system implementing ProSe.

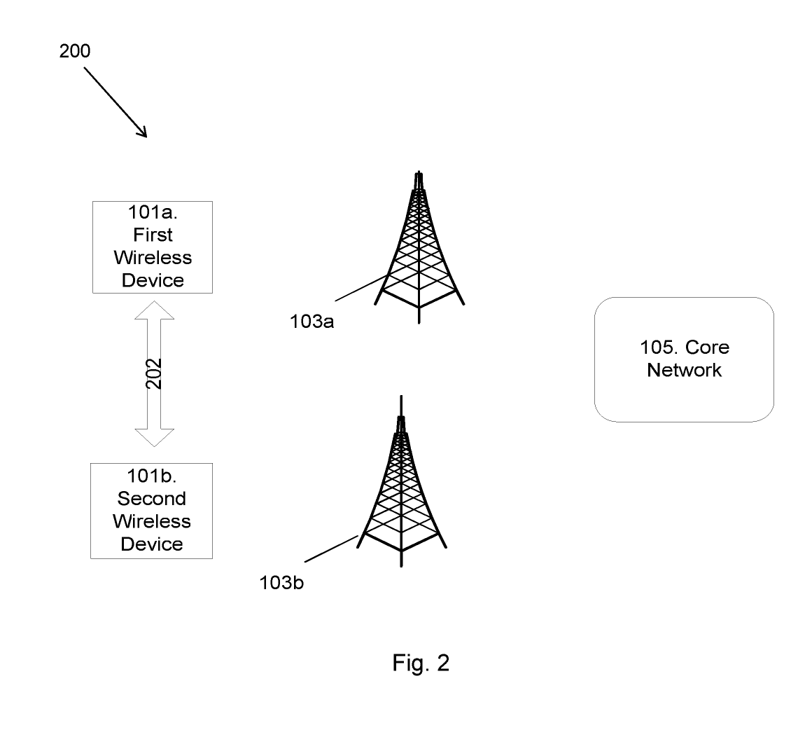

FIG. 3 is a schematic block diagram illustrating embodiments of a communications system.

FIG. 4 is a schematic block diagram illustrating embodiments of an LTE communications system.

FIG. 5 is a schematic block diagram illustrating embodiments of ProSe identities.

FIG. 6 is a schematic block diagram illustrating embodiments of an application authorization method.

FIG. 7 is a schematic block diagram illustrating embodiments of a ProSe registration request method.

FIG. 8 is a schematic block diagram illustrating embodiments of an application registration request method.

FIG. 9 is a schematic block diagram illustrating embodiments of a method for discovery authorization of other ProSe users.

FIG. 10 is a schematic block diagram illustrating embodiments of a method for ProSe user discovery.

FIG. 11 is a signaling diagram illustrating embodiments of a method.

FIG. 12 is a flow chart illustrating embodiments of a method performed by a first wireless device.

FIG. 13 is a schematic block diagram illustrating embodiments of a first wireless device.

FIG. 14 is a flow chart illustrating embodiments of a method performed by a network node.

FIG. 15 is a schematic block diagram illustrating embodiments of a network node.

The drawings are not necessarily to scale and the dimensions of certain features may have been exaggerated for the sake of clarity. Emphasis is instead placed upon illustrating the principle of the embodiments herein.

### DETAILED DESCRIPTION

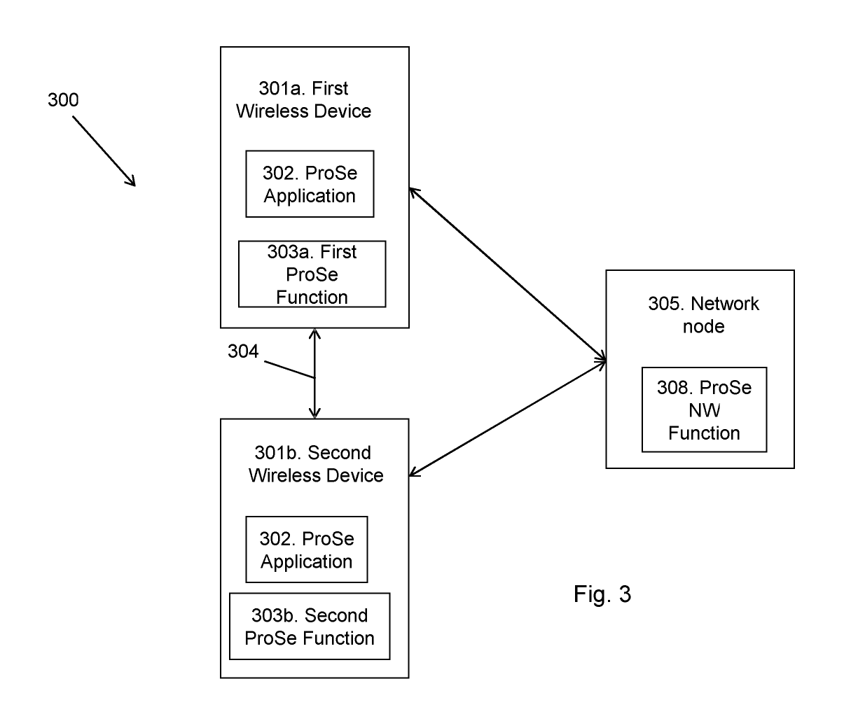

FIG. 3 depicts a communications system 300 in which embodiments herein may be implemented. The communications system 300 may in some embodiments apply to one or more radio access technologies such as for example Long Term Evolution (LTE), LTE Advanced, Wideband Code Division Multiple Access (WCDMA), Global System for Mobile Communications (GSM), or any other 3GPP radio access technology, or other radio access technologies such as WLAN. The communications system 300 implements ProSe.

The communications system 300 comprises a first wireless device 301a and a second wireless device 301b. When only the reference number 301 is used in the following, it refers to any one of the first wireless device 301a or the second wireless device 301b. A wireless device 301 which is enabled to use ProSe may be referred to as a ProSe wireless device or a ProSe enabled wireless device 301. Each wireless device 301 comprises at least one ProSe Application 302. Both wireless devices 301 are ProSe enabled which means that they fulfill “ProSe requirements for ProSe Discovery and/or ProSe Communication”, as defined by the 3GPP. According to the 3GPP, ProSe Communication is “A communication between two or more ProSe-enabled wireless devices in proximity by means of a ProSe Communication path” and ProSe Discovery is defined to be “A process that identifies that a ProSe-enabled wireless device is in proximity of another, using EUTRA (with or without E-UTRAN) or EPC”. Each wireless device 301 may be used by a user. The 3GPP defines the user as follows “An entity, not part of the 3GPP System, which uses 3GPP System services. Example: a person using a 3GPP System mobile station as a portable telephone”. Another term which is associated with the wireless device 301 is a subscriber. According to the 3GPP “A Subscriber is an entity (associated with one or more users) that is engaged in a Subscription with a service provider. The subscriber is allowed to subscribe and unsubscribe services, to register a user or a list of users authorized to enjoy these services and also to set the limits relative to the use that associated users make of these services”. A subscription may be described as the commercial relationship between the subscriber and the service provider. Each wireless device 301 comprises a respective ProSe Function 303, i.e. a first ProSe Function 303a and a second ProSe Function 303b. When the reference number 303 is used in the following, it refers to any of the first ProSe Function 303a and second ProSe Function 303b. Each Prose Function 303 in the respective wireless device 301 may be seen as a protocol layer which communicates with a corresponding layer in a network node 305, i.e. the discovery methods described herein which are run between the ProSe functions 303 in the wireless devices 301 and ProSe Network, NW, function 308 in the network node 305. The first wireless device 301a communicates with the second wireless device 301b using a ProSe communication path 304.

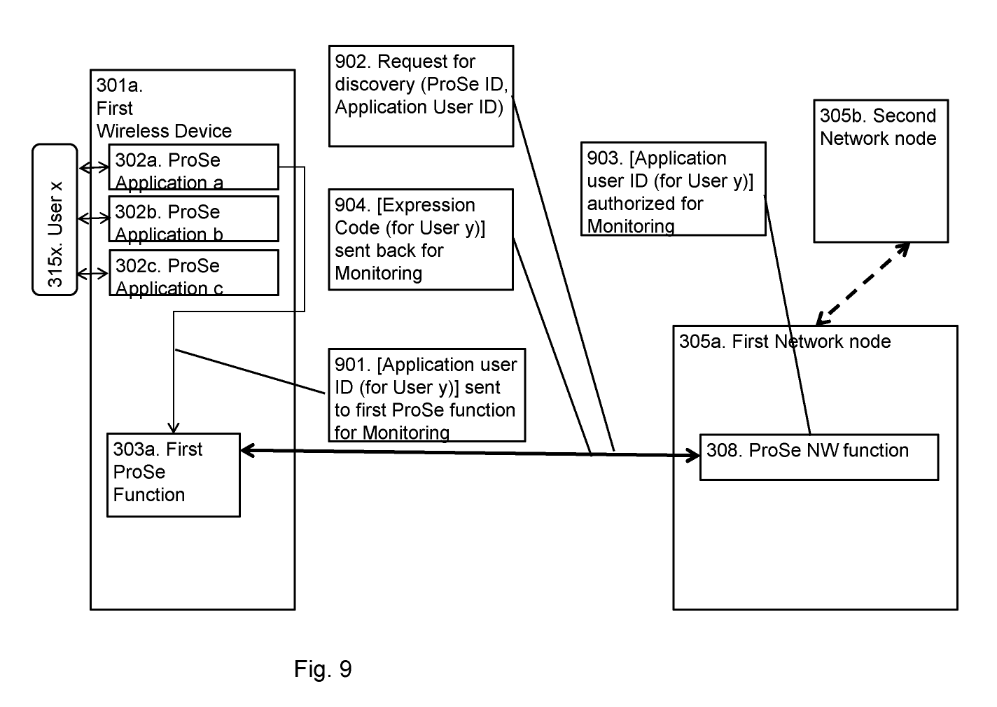

Both the wireless devices 301 are connected to an operator's network comprising at least one network node 305. As seen in FIG. 3, the communications system 300 comprises one network node 305. However, the communications system 300 may comprise any other number of network nodes, which will be exemplified with reference to FIG. 9 below. As mentioned above, a ProSe NW Function 308 may be located in the network node 305, it may be co-located in another existing network node or located in a separate network node dedicated to the ProSe function, e.g. a ProSe function node. The NW in the ProSe NW Function 308 is short for network, and is used in order to indicate that it is a ProSe NW Function 308 associated with and located in the network. This is in contrast to the ProSe Function 303 which is comprised in the wireless device 305. The network node 305 is associated with an operator. For the sake of simplicity, the communications system 300 in FIG. 3 shows only two wireless devices 301 and one network node 305. However, the communications system 300 may comprise any other suitable number of wireless devices 301 and network nodes 305.

Each wireless device 301 may be wireless devices by which a subscriber may access services offered by an operator's network and services outside operator's network to which the operators RAN and CN provide access, e.g. access to the Internet. The wireless devices 301 may be any device, mobile or stationary, enabled to communicate over a radio channel in the communications network, for instance but not limited to e.g. user equipment, terminal, mobile phone, smart phone, tables, sensors, meters, vehicles, household appliances, medical appliances, media players, cameras, M2M device, D2D device, IoT device, a client, or any type of consumer electronic, for instance but not limited to television, radio, lighting arrangements, tablet computer, laptop or PC. The wireless devices 301 may be portable, pocket storable, hand held, computer comprised, or vehicle mounted devices, enabled to communicate voice and/or data, via the RAN, with another entity, such as another wireless device or a server.

It should be noted that the communication link between the wireless devices 301 and between the wireless devices 301 and the network node 305 may be of any suitable kind and use any suitable protocol depending on type and level of layer (e.g. as indicated by the Open Systems Interconnection (OSI) model) as understood by the person skilled in the art.

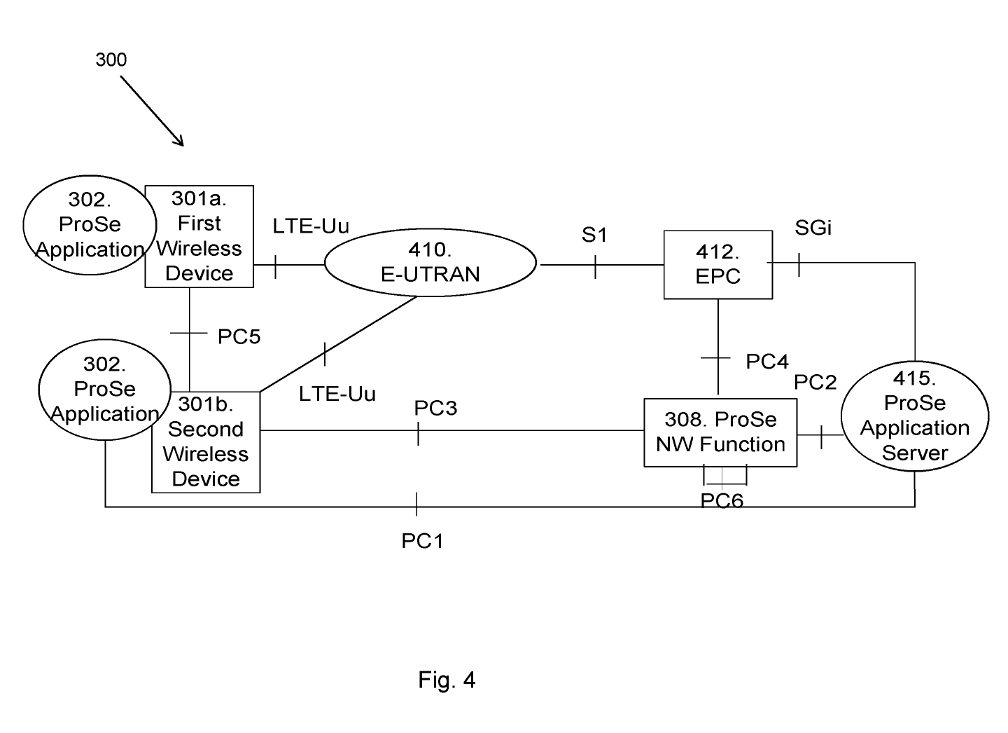

An embodiment where the communications system 300 is an LTE network is seen FIG. 4. The communications system 300 comprises two wireless devices, a first wireless device 301a and a second wireless device 301b. Each wireless device comprises a respective ProSe Application 302, as also see in FIG. 3. Each of the respective ProSe Applications 302 uses a ProSe capability for building the ProSe application functionality. An example may be for communication between members of Public Safety groups or for social media applications that requests to find buddies in proximity. The reference point between the two wireless devices 301 is called PC5 and is used for control and user plane for discovery and communication, for relay and one-to-one communication between the wireless devices 301 directly and between the wireless devices 301 over the LTE-Uu reference point. The LTE-Uu reference point is between the wireless devices 301 and E-UTRAN 410. E-UTRAN 410 is connected to the Evolved Packet Core (EPC) 412 via the S1 reference point. The EPC 412 comprises network nodes such as e.g. a Mobility Management Entity (MME), a Serving GateWay (SGW), a Packet data network GateWay (PGW), a Policy and Charging Rules Function (PCRF) node, a subscriber database such as a Home Subscriber Server (HSS) or a Home Location Register (HLR) etc. The second wireless device 301b is connected to the network associated ProSe NW Function 308 via a PC3 reference point. PC3 is used to define the interaction between the second wireless device 301b and the ProSe NW Function 308 for example for configuration for ProSe discovery and communication. The ProSe NW Function 308 may be implemented in a dedicated ProSe node or co-located in an existing node in the communications system 300, e.g. in one of the entities in the EPC 412 such as the network node 305 illustrated in FIG. 3. The ProSe NW Function 308 is connected to the EPC 412 via the PC4 reference point. PC4 is used to define the interaction between EPC 412 and the ProSe NW Function 308 such as for example when setting up a one-to-one communication path between the wireless devices 301 or when validating ProSe services (authorization) for session management or mobility management in real time. The reference point PC6 seen in FIG. 4 is a reference point which may be used for functions such as ProSe Discovery between users subscribed to different Public Land Mobile Networks (PLMNs). The ProSe NW Function 308 is connected to a ProSe Application Server 415 via a PC2 reference point. PC2 is used to define the interaction between the ProSe Application Server 415 and the ProSe functionality provided by the 3GPP Evolved Packet System (EPS) via the ProSe NW Function 308. One example may be for application data updates for a ProSe database in the ProSe NW Function 308. Another example may be data for use by the ProSe Application Server 415 in interworking between 3GPP functionality and application data, e.g. name translation. The ProSe Application Server 415 comprises at least one ProSe Application. The at least one ProSe Application comprised in the ProSe Application Server 415 is the same ProSe Application 302 which is comprised in the wireless device 301. The ProSe Application Server 415 is on the “Internet”, i.e. it is not part of the operator's network. The ProSe Application Server 415 is owned by a third party such as e.g. a 911 alarm service, Facebook, Google etc. This is contrary to the ProSe NW Function 308 which is owned by the network operator. The ProSe Application 302 in the second wireless device 301b is connected to the ProSe Application Server 415 via a PC1 reference point. PC1 is used to define application level signaling. The ProSe Application Server 415 is connected to the EPC 412 via the SGi reference point which may be used for application data and application level control information exchange.

As mentioned above, ProSe Identities is one of the unsolved issues in 3GPPs work related to ProSe. A ProSe enabled wireless device 301 needs to be able to discover other ProSe enabled wireless devices 301 and to be discoverable by other ProSe enabled wireless devices 301. The discoverable wireless device 301 needs to announce its identity. The discovering wireless device 301 needs to be able to extract the identity of the announcing wireless device 301. The mechanism may be e.g. a push or pull mechanism such that the discovery process is initiated by the announcer or by the monitoring wireless device 301. The mechanism may depend on the settings for the method. The method of discovery may, according to some requirements, be a restricted discovery method or an open discovery method, i.e. ProSe Discovery that only takes place with explicit permission from the wireless device 301 being discovered or ProSe Discovery without explicit permission from the wireless device 301 being discovered. The restricted discovery method will be discussed herein.

An assumption for the discussion below is that the wireless device 301 may be used by different users at different times. This may be a common scenario for the Public Safety use cases. This may also apply to commercial uses cases when e.g. a family may share usage of a tablet. The different users are treated as users in the application level, but there is a need to make a connection at some level between the application level users and the wireless device 301, which will be done in the ProSe level.

The different ProSe identities will now be described, and the methods using the ProSe identities will be described later.

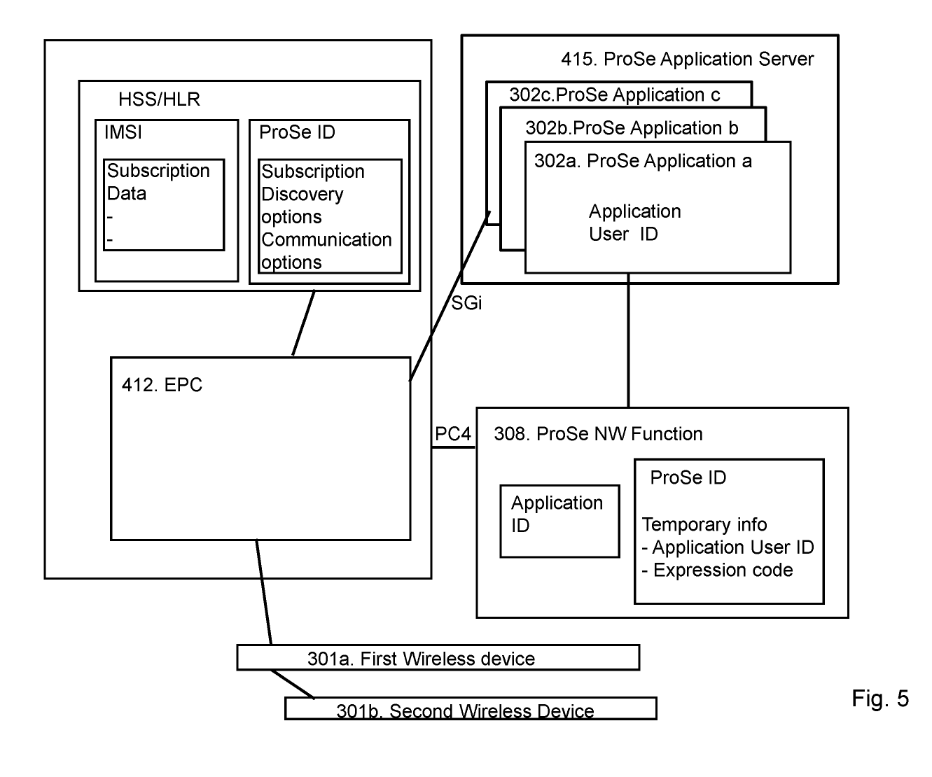

An overview of the following ProSe identities is shown in FIG. 5:
Application ID
ProSe ID
Application User ID
Expression Code

In some embodiments, the Application ID may be referred to as an APP ID or ProSe Application ID, the ProSe ID may be referred to as a ProSe User ID, the Application User ID may be referred to as an APP User ID or an Application Layer User ID and the expression code may be referred to as an announcing code.

It may be assumed that there is a record of the subscription for ProSe saved in the operator's network, indicating ProSe specific subscription data for ProSe functionality. The ProSe record may be comprised in both the subscriber database, e.g. the HSS or the HLR, and in the ProSe NW Function 308 in the network. The record may comprise permanent data and/or temporary data. Permanent subscription data may be data to be stored on a long term basis and connected to the subscription of the user/wireless device 301. The temporary data may be of changeable nature, such that the life time of these records may be during a session or during an attach of the wireless device 301. Permanent data in the subscription may be e.g. the type of discovery and communication that is allowed or range class allowed for the wireless device 301. Allowed ProSe applications 302 may be stored in the long-lived part of the ProSe records. Temporary data may be of the type that is either data which needs to be updated or which is preferred to be updated, such as temporary identifications used in the discovery and communication methods, temporarily used options in the wireless device 301 or records of settings due to specific usage of certain options or ProSe applications.

Application ID: The Application ID, also referred to as APP ID or ProSe Application ID, is an application ID identifying the application running in the wireless device 301, such that the network node 305 may identify, and authorize the usage of ProSe functionality by the application in question. The network ProSe function 408 authorizes that the application may be used for ProSe.

ProSe ID: The ProSe ID, also referred to as a ProSe User ID, is a subscription parameter identifying the ProSe subscriber and the records for ProSe parameters and ProSe options for the specific ProSe user. This ProSe ID should be one-to-one identifiable to an International Mobile Subscriber Identity (IMSI) for a subscription for a ProSe enabled wireless device 301. In some embodiments, the connection between the IMSI and the ProSe ID is done at the time a user is registered to use ProSe. In other embodiments, the ProSe ID is a part of the subscription already from the start, i.e. already connected to the IMSI at subscription. As such, the ProSe ID is only allocated to ProSe enabled wireless device's 301 subscribers and thus not available generally for all subscribers. The ProSe ID is used to build and store ProSe records for the ProSe enabled wireless device's 301/subscribers. The ProSe ID may be stored in the network node 305. When the user performs the ProSe registration towards the ProSe NW Function 308 in the network node 305, a certificate method is used to authenticate the ProSe user by use of its ProSe ID. ProSe ID records for the ProSe enabled wireless devices 301/subscribers may be stored in e.g. the subscriber database, such as the HSS or HLR, or in a ProSe specific repository e.g. in the ProSe NW Function 308 or in any other network node suitable for storing the ProSe ID. Summarized, the ProSe ID identifies one ProSe Function 303 located in one wireless device 301. There is one subscription to the wireless device 301, and there is at least one user using the subscription. In some embodiments, a subscription may have a ProSe ID. In other embodiments, the ProSe ID is created when the wireless device 301 is registered in the ProSe NW Function 308 in the network. In the latter embodiment, there is only an indication in the subscription indicating that the subscriber can use ProSe and the actual ProSe ID is created upon registration. In the following the term ProSe ID may be used in connection with any one of the ProSe Function 303 in the first wireless device 301a, the second wireless device 301b, the user and subscription.

Application User ID: The APP User ID, also referred to as an APP User ID or an Application Layer User ID, is an ID used by an application to identify an application user which is ProSe enabled. This Application User ID may be used for e.g. discovery of “friends” in the application. The term “friend” refers to another user of the same application which is in the contact list or group of the current user, e.g. a user's contacts in a social network application. The Application User ID may be stored as an entry in the ProSe record database for the user, such that the ProSe function may find the ProSe ID and the actual ProSe enabled wireless device 301 based on the Application User ID, provided that the user has registered as a ProSe Application user in the ProSe record database. The ProSe record database may be a temporary ProSe record database. The ProSe record database may be located in a ProSe specific repository e.g. in the ProSe NW Function 308 or in any other network node suitable for storing the ProSe ID. If the application in the wireless device 301 may provide information about the home network of friends to be discovered, the Application User ID may be amended with a network part which is used by the EPS network. The network part is used to identify the user as a Mobile Networkn Operator (MNO) subscriber and for a visited network to route requests to the home network of the user. The amended Application User ID may take the form of a Network Access Identifier (NAI) including an Application User ID, and the Application name, together with the Home MNO of the subscriber, e.g. john_doe@facebook.<xxx>mcc.<zzz>mnc.com.

Expression Code: The Expression Code, also referred to as an announcing code, is an identity which the ProSe enabled wireless devices 301 use for broadcasting its identity and it is used in discovery. The expression code is an alias for the ProSe ID for ProSe enabled users. The expression code may be sent in open or as an encrypted expression. Due to privacy requirements, the expression code may be encoded using some RAND part as well as the ProSe ID and may also be allocated on a temporary basis and renewed at certain time intervals. The expression code may comprise a global part and/or an operator specific part. The expression code may also comprise information regarding the duration of the expression code, i.e. the time for which the current expression code is valid. The expression may comprise information regarding an application and/or application category. The expression code may also be referred to as expression ID.

The ProSe identities above may be of any suitable format and size. At least one of the identities mentioned above is needed in the ProSe discovery methods. Some ProSe methods using the above parameters will now be described, starting with a method for application authorization.

### Application Authorization

A ProSe application 302 comprised in a wireless device 301 may be under the control of the operator or it may be a third party developed application. The ProSe application's use of ProSe needs to be under the control of the operator. The ProSe application 302 should be recognized and authorized to use ProSe by the operator.

The first wireless device 301a comprises, by pre-loading or by downloading and installation, a number of ProSe enabled applications 302. These ProSe applications 302 may be invoked by the user of the wireless device 301 at any time. The ProSe application 302 may be a pre-authenticated application in the wireless device 301, the Subscriber Identity Module (SIM) comprised in the wireless device 301 or it may be done on-line by the ProSe NW Function 308 in the operator network.

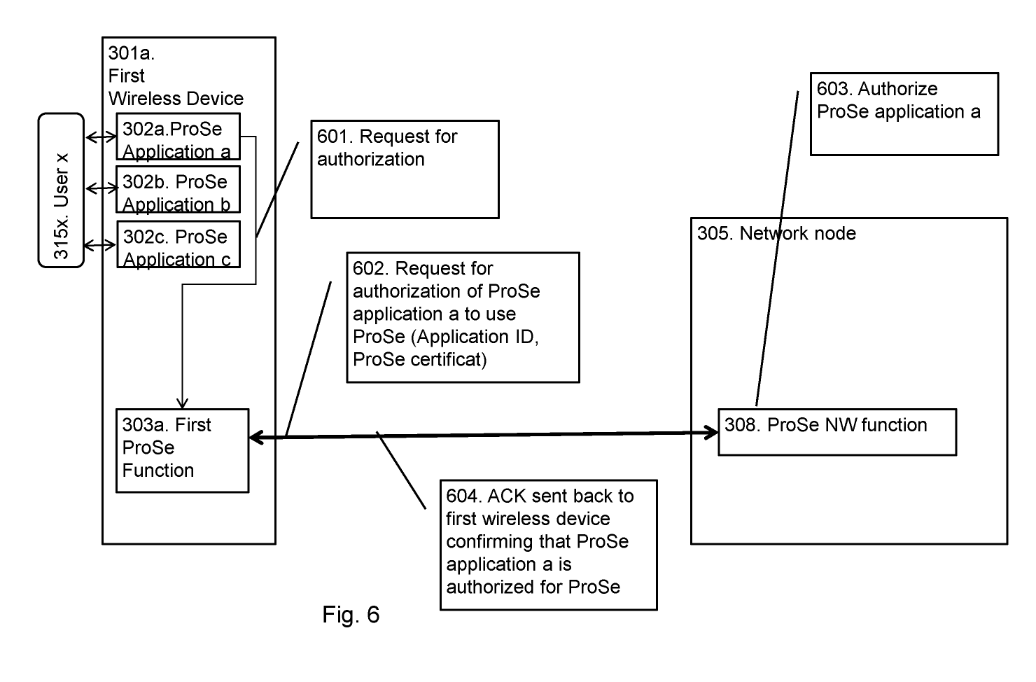

After the first wireless device 301a has attached to the network node 305 and found the ProSe NW Function 308 in the network node 305, the ProSe user, indicated as user x 315x in FIG. 6, may try to get authorization for the ProSe application 302 to use ProSe by invoking the application authorization method, as illustrated in FIG. 6. The application authorization may also be referred to as ProSe registration. In FIG. 6, the first wireless device 301a is shown to comprise three ProSe applications, ProSe application a 302a, ProSe application b 302b and ProSe application c 302c. However, the skilled person will understand that the first wireless device 301a may comprise any other suitable number of ProSe applications 302 than illustrated in FIG. 6 and possibly also non-ProSe applications (not shown). The application authorization comprises the following steps, which steps may be performed in any suitable order than described below:

### Step 601

When the user x 315x invokes the ProSe application a 302a in the first wireless device 301a, the ProSe application a 302a sends a request for authorization towards the first ProSe function 303a in the first wireless device 301a. The first ProSe function 303a in the first wireless device 301a needs to assess if the ProSe application a 302a in the first wireless device 301a is authorized or not to use the ProSe capability features.

### Step 602

In case the ProSe application a 302a in the first wireless device 301a is not already authorized by the first ProSe function 303a in the first wireless device 301a, the first ProSe function 303a in the first wireless device 301a sends a request towards the ProSe NW Function 308 in the network node 305 for authorization of the ProSe application a 302a to use ProSe. The ProSe application a 302a shall be identified, authenticated and authorized. The first wireless device 301a will send an Authorization Request towards the ProSe NW Function 308, including the Application ID and a ProSe certificate. A ProSe certificate may be a certificate that is used by the ProSe Function 303 in order to be able to carry out the authorization in the network node 305. The ProSe certificate may be of any suitable type.

### Step 603

Based on the request, the ProSe application a 302a is identified by the network node 305 and authorized to use ProSe.

### Step 604

If the ProSe Application a 302a was authorized in step 603, the network node 305 transmits an acknowledgement (ACK) to the first wireless device 301a, i.e. to the first ProSe function 303a and the ProSe application a 302a, confirming that the ProSe application a 302a is authorized to use ProSe.

### Registration in Order to be Discoverable

The ProSe application a 302a in a first wireless device 301a may request the first ProSe function 303a in the first wireless device 301a to be discoverable by other wireless devices, e.g. the second wireless device 301b. The operator may have a policy for the options for discovery. The network node 305 need to be accessed in order for the discovery to be authorized by the network node 305. The requested discovery options chosen by the user x 315x is sent from the ProSe application a 302a to the first ProSe function 303a in the first wireless device 301a. The first ProSe function 303a in the first wireless device 301a forwards the requested discovery options to the ProSe NW Function 308 in the network node 305. If the first wireless device 301a is roaming, the request will be forwarded from the visited ProSe function to the users home network ProSe function. The user x 315x is identified by a ProSe ID, which is a permanent ID for the ProSe users specific options stored in the home network, possibly in a subscriber database such as the HSS or in any other database related to the ProSe function.

In some embodiments, each application 302 in the wireless device 301 may announce itself, i.e. the announcing wireless device 301 may announce multiple codes in broadcast messages so that each application 302 in the wireless device 301 may be announced and discovered individually. Thus, there may be one or multiple IDs per wireless device 301. This means that the network node 305 may identify and authorize the usage of ProSe functionality by the ProSe application 302. In addition, other wireless devices 301 may discover wireless device-ProSe application combinations.

The ProSe ID is a unique identity for the ProSe user x 315x, possibly created from the IMSI. It is composed of parts indicating to the network node 305 where the first wireless device 301a has its subscription. This is used in order for the ProSe NW Function 308 to find the related ProSe function in the Home network for roaming wireless devices 301. During this authorization method, the ProSe NW Function 308 in the network node 305 assigns a temporary expression code to the the ProSe user x 315x that the ProSe user x 315x will broadcast in order to be discoverable by other ProSe users.

When the discovery is requested by the user x 315x or by the ProSe application a 302a, the Application ID and the Application User ID is stored in the network node 305 as temporary information in the ProSe records for the ProSe user x 315x, as also illustrated in FIG. 5.

If another ProSe application 302 such as e.g. ProSe application b 302b will register in the first wireless device 301a, it shall be registered in the network node 305, but there will not be a new expression code assigned. When all Application User IDs have deregistered, any new expression code may be assigned.

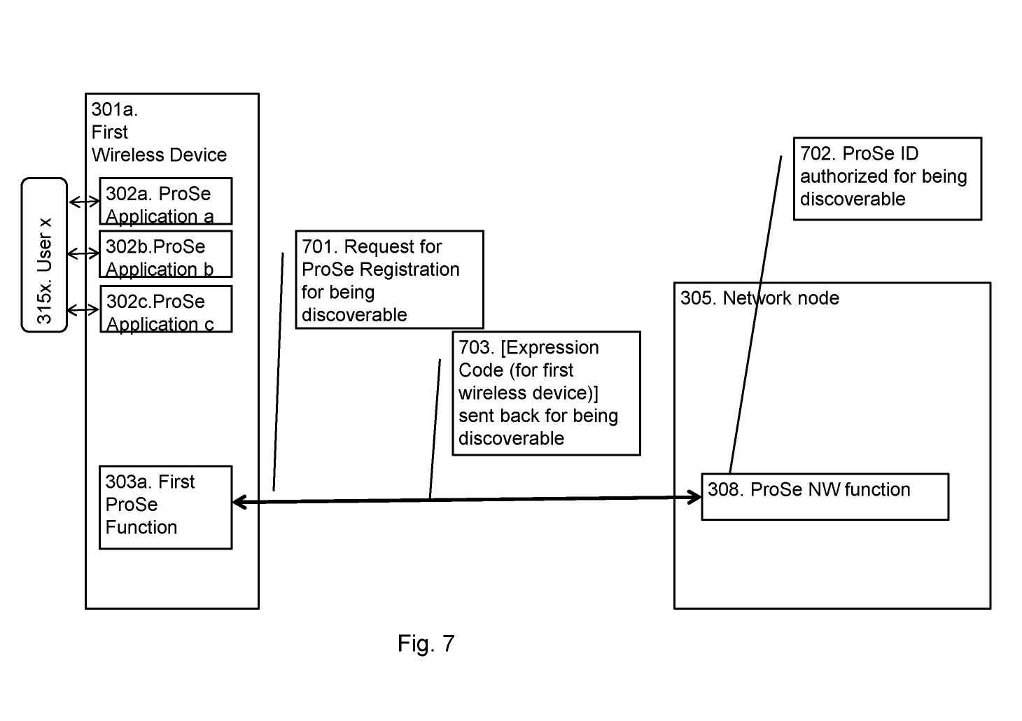

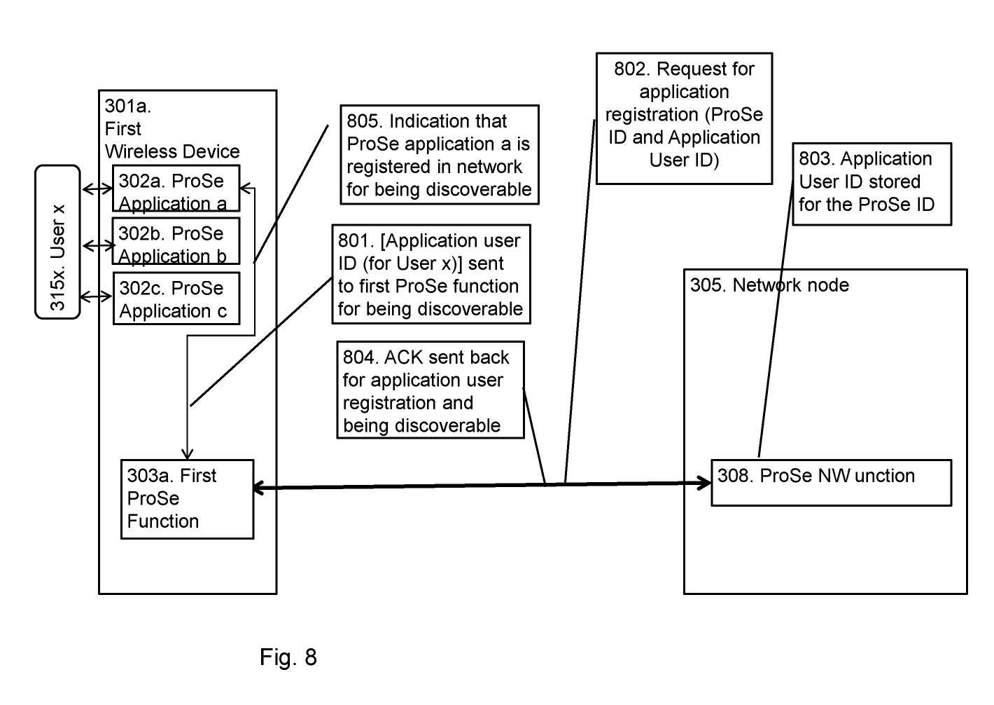

The registration method may be divided in two steps, ProSe registration request and Application registration request. The ProSe registration request method is illustrated in FIG. 7 and the Application registration request is illustrated in FIG. 8. FIG. 7 will now be described and the ProSe registration request method comprises the following steps performed in any suitable order than described below:

### Step 701

The first ProSe function 303a in the first wireless device 301a, after doing EPS Attach, will send a request for ProSe Registration towards the ProSe NW Function 308 in the network node 305 for being discoverable. The first ProSe function 303a is identifying itself by the ProSe ID.

### Step 702

The ProSe NW Function 308 in the network node 305 authorizes the first wireless device 301a for being discoverable and provides an expression code to the first wireless device 301a. In other words, the ProSe ID is authorized for being discoverable.

### Step 703

The expression code for the first wireless device 301a is sent back from the ProSe NW Function 308 to the first wireless device 301a for being discoverable.

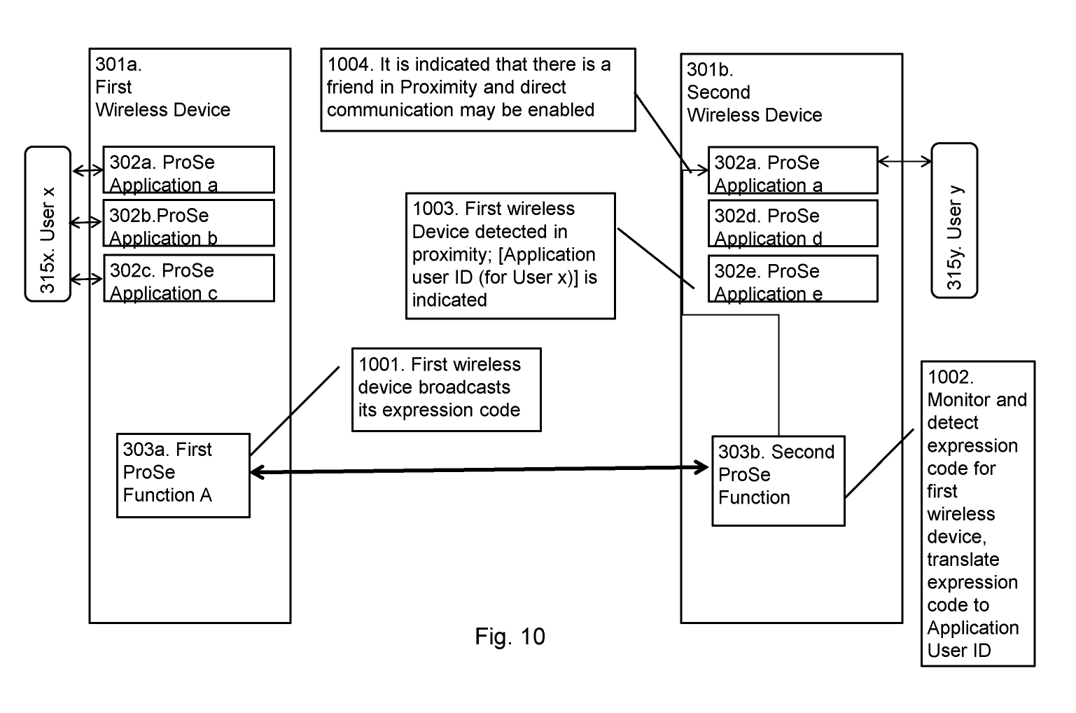

In the discovery process the network node 305 is involved in allowing which wireless device 301 can discover which wireless device. For example, the first wireless device 301a (being used by user x 315x) wants to be discovered by its friends, but not by the second wireless device 301b (being used by user y 315y) of the second wireless device 301b specifically. User y 315y is not shown in FIG. 7, but reference is made to FIG. 10 illustrating the user y 315y. When the second wireless device 301b wants to discover the first wireless device 301a, the second wireless device 301b will ask the network node 305 for the code of the first wireless device 301a, but in this case the network node 305 will make the decision not to send the code of first wireless device 301a to the second wireless device 301b. So the second wireless device 301b will not be able to monitor and find the first wireless device 301a. In another embodiment, the second wireless device 301b will start monitoring all its neighbors and will receive the encrypted code from the first wireless device 301a. Since the code for the first wireless device 301a is encrypted, the second wireless device 301b will not know who has sent it. The second wireless device 301b will ask the network node 305 to decrypt the code. Now the network node 305 knows that the first wireless device 301a does not allow to be discovered by the second wireless device 301b, and therefore the network node 305 will reject the request from the second wireless device 301b for decryption. Thus, the network node 305 may be involved early or late in the discovery process.

An embodiment of the application registration request method will now be described with reference to FIG. 8. The method illustrated in FIG. 8 comprises the following steps, which steps may be performed in any suitable order than described below:

### Step 801

The ProSe application a 302a in the first wireless device 301a requests from the first ProSe function 303a in the wireless device 301a to be discoverable. The ProSe application a 302a uses an Application User ID in the request to identify the application user x 315x.

### Step 802

The first ProSe function 303a in the first wireless device 301a will send a request for Application Registration towards the ProSe NW Function 308 in the network node 305. It is identifying itself by the ProSe ID and provides the Application User ID to the ProSe NW Function 308.

### Step 803

The ProSe NW Function 308 in the network node 305 stores the Application User ID in the temporary record for the ProSe ID.

### Step 804

The ProSe NW Function 308 in the network node 305 sends an acknowledgement towards the first ProSe function 303a in the first wireless device 301a to acknowledge the request sent in step 802 and for application user registration and being discoverable.

### Step 805

The first ProSe function 303a indicates to the ProSe application a 302a that it is registered in the network node 305 for being discoverable.

### Authorization for Discovery

The ProSe application a 302a in the first wireless device 301a may request discovery of a ProSe user or several ProSe users, e.g. user x 315x. According to the 3GPP SA1 requirements the request may also be for a user category to be discovered. The operator policy for discovery needs to be enforced and the first wireless device 301a shall request the discovery authorization from the ProSe NW Function 308 in the network node 305. A request is sent to the local first ProSe function 303a in the first wireless device 301a. In this case the network policy options need to be stated for the requester and for the requested users. For the requester, possibly a home network for a roaming first wireless device 301a needs to be contacted. For the requested discovered ProSe users, their home networks need also be contacted such that operator policy is enforced.

For the discovery of other ProSe wireless devices 301, e.g. second wireless device 301b there is a need for their expression codes to be known when they are the broadcast to be monitored. Their expression codes(s) may be provided by their home operator ProSe NW Function 308. The network node 305 needs to find the home operator of the requested and discovered second wireless device 301b. This information may be provided to the ProSe NW Function 308 by the requesting first wireless device 301a or the ProSe Application Server 415.

In case the first wireless device 301a may provide the home network information of the requested second wireless device 301b, it may send it to the network node 305. The ID of the requested discovered second wireless device 301b may comprise the home operator code for the discovered second wireless device 301b. In this case such knowledge may be possessed by the requesting ProSe application 302 in the first wireless device 301a. However, how can the ProSe application 302 in the first wireless device 301a know the home network of the requested second wireless device 301b? In some embodiments, the ProSe enabled application server 415 stores and may provide such information for its ProSe enabled wireless devices 301 to the discovering wireless device ProSe application 302 by request. In other embodiments, the information indicating the home network of the requested second wireless device 301b may be configured into the discovering wireless device ProSe application 302 which network node 305 the friends in the ProSe application friend list has subscribed to.

When the ProSe enabled application server 415 stores such information for its ProSe enabled wireless devices 301 it may be requested over the PC2 reference point by the ProSe NW Function 308. In this case the wireless device 301 only needs to send an Application User ID towards the ProSe NW Function 308 in the network node 305.

The home network ProSe NW Function 308 shall be able to find the records for the ProSe wireless devices 301 to be discovered by the Application User ID. Thus, the Application User ID needs to be stored for the wireless device 301 identified by the ProSe ID in the Home network subscriber database (e.g. HSS) or the ProSe NW Function 308. Based on the finding of the wireless device 301, the expression code which the wireless device 301 is currently using may be found and sent back to the monitoring wireless device 301, such that the requested wireless device 301 may be discovered.

When a group of wireless devices 301 are to be monitored, the requesting ProSe application 302 may simply repeat the request towards the ProSe function 303 in the wireless device 301a number of times. A service primitive in the ProSe function Application Programming Interface (API) in the wireless device 301 may otherwise take a number of wireless devices 301 as argument, i.e. a list of ProSe wireless device 301 to be monitored.

A method for discovery authorization of other ProSe users is shown in FIG. 9. In FIG. 9, the communications system 300 comprises two network nodes, i.e. a first network node 305a and a second network node 305b. Note that when only the reference number 305 is used herein it refers to any network node, e.g. the first network node 305 or the second network node 305b or any other network node not shown in any of the figures. FIG. 9 illustrates a case when a user y 315y is registered in the second network node 305b, illustrated with a dashed line. The second network node 305b may in this embodiment be referred to as a home network node. The embodiments of the method for discovery authorization exemplified in FIG. 9 comprise the following steps, which steps are performed in any suitable order than described below:

### Step 901

The ProSe application a 302a in the first wireless device 301a requests from the first ProSe function 303a in the first wireless device 301a to discover/monitor the “user y 315y” identified by its respective Application user ID. In other words, the ProSe application a 302a in the first wireless device 301a sends the application user ID for user y 315y to the first ProSe function 303a for monitoring.

### Step 902

The first ProSe function 303a in the first wireless device 301a will send a request for Discovery towards the ProSe NW Function 308 in the network node 305. The request is a request to discover user y 315y which also uses the ProSe application a 302a but in another wireless device, e.g. second wireless device 301b. The first ProSe Function 303a is identifying itself by the ProSe ID and provides the Application User ID (or IDs) to be discovered.

### Step 903

The ProSe NW Function 308 in the network node 305 searches for the Application User ID to be discovered in its own network, i.e. first network node 305a. If this Application User has registered, the Application User ID will be stored in the ProSe record for that ProSe User. If the Application User ID is not found, it may request the Application Server 415 for the network where the Application User y 315y is subscribed/registered, i.e. the second network which comprises the second network node 305b. If the first wireless device 301a could already provide this information, i.e. the network where the Application User y 315y is subscribed/registered, the request towards the Application Server 415 is not needed.

### Step 904

The ProSe ID record of the requested Application User stores the expression code for the ProSe User, i.e. user y 315y. The expression code for ProSe User y 315y is sent from the ProSe NW Function 308 back to the requesting first ProSe Function 303a for monitoring.

### Step 905 (not Shown in FIG. 9)

The requesting first wireless device 301a starts monitoring for the expression code of the friend, i.e. user y 315y.

### Discovery Event

The monitoring and the broadcasting functions as described above may result in a match of expression codes in the monitoring first ProSe function 303 in the first wireless device 301a. When a match is found, the monitoring first ProSe function 303a in the first wireless device 301a translates the expression to the Application user ID which was requested by the ProSe application a 302a in the previous discovery request. The ProSe application a 302a in the first wireless device 301a which issued the monitoring request is notified by the first ProSe function 303a in the first wireless device 301a about the match, while other potential ProSe applications in the first wireless device 301a are not notified.

FIG. 10 illustrates an embodiment of a ProSe user's discovery method. FIG. 10 illustrates two wireless devices, the first wireless device 301a and the second wireless device 301b. The first wireless device 301a comprises three ProSe Applications (ProSe Application a 302a, ProSe Application b 302b and ProSe Application c 302c) and one ProSe Function (the first ProSe Function 303a). The second wireless device 301b comprises three ProSe Applications (ProSe Application a 302a, ProSe Application d 302d and ProSe Application e 302e) and one ProSe Function (the second ProSe Function 303b). Note that the ProSe Application a 302a is comprised in both the first wireless device 301a and the second wireless device 301b. The method comprises the following steps, which steps may be performed in any suitable order than described below:

### Step 1001

The first wireless device 301a broadcasts its expression code. In some embodiments, it is the first ProSe Function 303a in first wireless device 301a which broadcasts the expression code.

### Step 1002

The second wireless device 301b monitors the expression code of the first wireless device 301a, detects the first wireless device 301a and translates the expression code to the Application User ID of the earlier requested user x 315x of ProSe application a 302a.

### Step 1003

The first wireless device 301a is detected in proximity. The Application User ID associated with the first wireless device 301a is sent from the second ProSe Function 303b towards the ProSe application a 302a in the second wireless device 301b for being in proximity.

### Step 1004

Based on the Application User ID from step 1003, the ProSe application a 302a knows that there is a friend in proximity, i.e. user y 315y, and that direct communication with the friend, i.e. user x 315x, may be enabled.

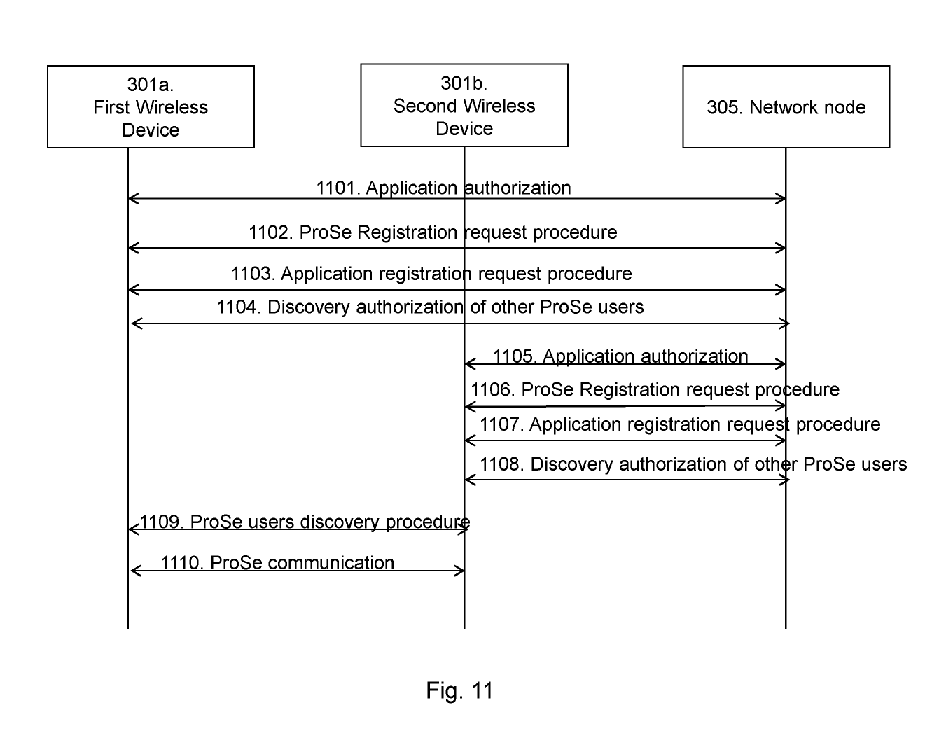

The methods described above, according to some embodiments will now be described with reference to the signaling diagram depicted in FIG. 11. As above, FIG. 11 illustrates an example embodiment involving two wireless devices 301 and one network node 305. However, the method equally applies to any number of wireless devices and network nodes. The method comprises the following steps, which steps may as well be carried out in another suitable order than described below.

### Step 1101

The first wireless device 301a performs an application authorization procedure towards the network node 305. This step is shown in more detail in FIG. 6. After this step has been performed at least one ProSe application 302 of the first wireless device 301a is authorized to use ProSe. The first wireless device 301a may perform this step for one or more of its ProSe applications 302. The operator has recognized and authorized the ProSe application 302.

### Step 1102

The first wireless device 301a performs a ProSe Registration request procedure towards the network node 305. This step is shown in more detail in FIG. 7. After this step has been performed, the network node 305 has authorized the first wireless device 301a for being discoverable. In case the first wireless device 301a is roaming, this step may involve communication with its home network.

### Step 1103

The first wireless device 301a performs an application registration request procedure towards the network node 305. This step is shown in more detail in FIG. 8. After this step has been performed, the first wireless device 301a and the ProSe application 302 in the first wireless device 301a are registered in the network node 305 for being discoverable. The first wireless device 301a performs this step for one or more of its ProSe applications 302.

### Step 1104

The first wireless device 301a performs a procedure for discovery authorization of other ProSe users, i.e. of other ProSe enabled wireless devices 301 such as e.g. the second wireless device 301b. This step is shown in more detail in FIG. 9. After this step has been performed, the first wireless device 301a is discoverable and may discover other ProSe users, i.e. other ProSe enabled wireless devices 301.

### Steps 1105-1108

These steps correspond to steps 1101-1104 described above, but involves the second wireless device 301b instead of the first wireless device 301a. The steps will therefore not be repeated for the sake of simplicity. Steps 1105-1008 may be performed after steps 1101-1104 or before steps 1101-1104 or in parallel with steps 1101-1104. The steps 1101-1104 are shown in more detail in FIGS. 6-9.

After steps 1101-1108 has been performed, regardless of in which order they are performed, both wireless devices 301a, 301b are discoverable and may discover other wireless devices, e.g. each other.

### Step 1109

The first wireless device 301a and the second wireless device 301b perform a ProSe user discovery procedure with each other. This step is shown in more detail in FIG. 10.

### Step 1110

In order for this step to be performed, all steps 1101-1109 needs to have performed earlier. The first wireless device 301a and the second wireless device 301b execute ProSe communication with each other. The communication may be transmission of data, voice etc. using the direct link 304 between them and via the reference point PC5 in case the communications system 300 is an LTE network.

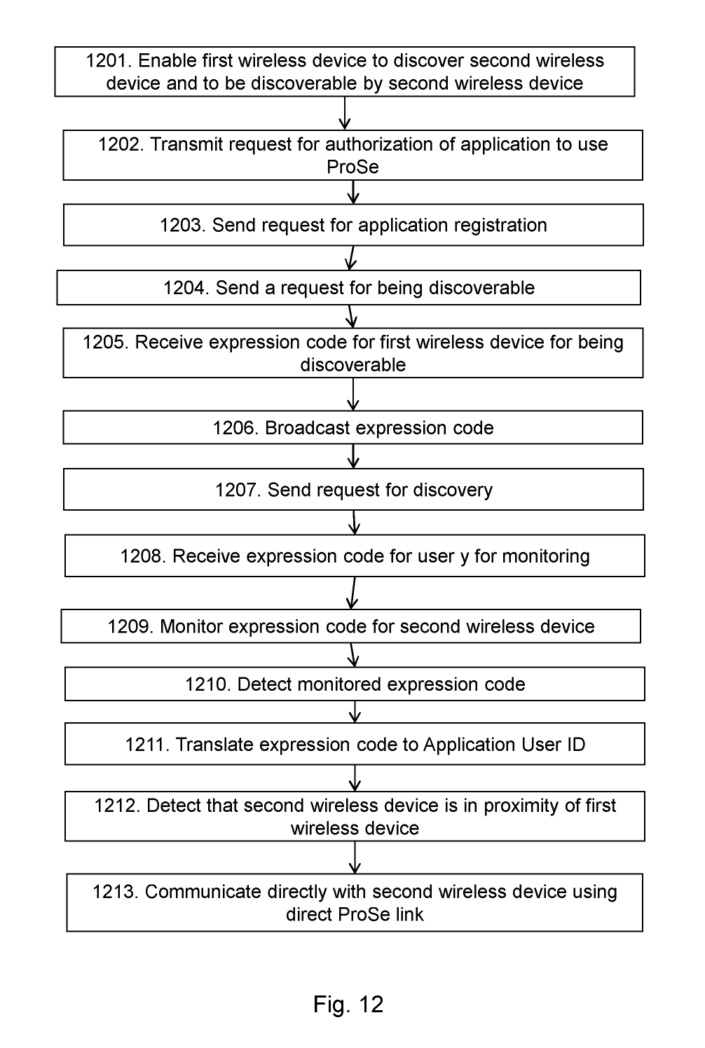

The method described above will now be described seen from the perspective of the first wireless device 301a. FIG. 12 is a flowchart describing the present method in the first wireless device 301a for enabling ProSe communication in the communications network 300. In some embodiments, the first wireless device 301a comprises an application 302 used by a user x 315x. An application 302 in the first wireless device 301a may request a first ProSe function 303a in the first wireless device 301a to be discoverable by other wireless devices. The first wireless device 301a is in proximity of a second wireless device 301b. The method comprises the following steps to be performed by the first wireless device 301a:

### Step 1201

Using at least one of an Application ID, ProSe ID, Application User ID and expression code, the first wireless device 301a enables itself, i.e. the first wireless device 301a, to discover the second wireless device 301b and to be discoverable by the second wireless device 301b.

The Application ID may identify an application 302 running in the first wireless device 301a or the second wireless device 301b. The ProSe ID may identify a first ProSe Function 303a located in the first wireless device 301a. The ProSe ID may be allocated to a subscriber of a ProSe enabled first wireless device 301a. The Application User ID may be an ID used by an application 302 to identify an application user which is ProSe enabled. The expression code may be an identity which the first wireless device 301a uses for broadcasting its identity when it is ProSe enabled.

In some embodiments, the Application ID is a ProSe Application ID, the ProSe ID is a ProSe User ID, the Application User ID is an Application Layer User ID and the expression code is an announcing code.

### Step 1202

This step corresponds to step 602 in FIG. 6 and step 1101 in FIG. 11. In some embodiments, the first wireless device 301a transmits, towards the ProSe NW Function 308 in the network node 305, a request for authorization of an application 302 in the first wireless device 301a to use ProSe.

### Step 1203

This step corresponds to step 802 in FIG. 8. In some embodiments, the first wireless device 301a sends a request for application registration towards the ProSe NW Function 308 in the network node 305. The first wireless device 301a identifies itself by the ProSe ID and the Application User ID.

### Step 1204

This step corresponds to step 701 in FIG. 7. In some embodiments, the first wireless device 301a is enabled to be discoverable by the second wireless device 301b by sending 701, to the ProSe NW Function 308 in a network node 305, a request for being discoverable. The ProSe Function 303a in the first wireless device 301a, which may be the entity in the first wireless device 301a that sends the request, identifies itself with a ProSe ID in the request.

### Step 1205

This step corresponds to step 703 in FIG. 7. In some embodiments, the first wireless device 301a is enabled to be discoverable by the second wireless device 301b by receiving, from the ProSe NW Function 308 in the network node 305, the expression code for the first wireless device 301a for being discoverable.

### Step 1206

This step corresponds to step 1001 in FIG. 10. In some embodiments, the first wireless device 301a is enabled to be discoverable by the second wireless device 301b by broadcasting the expression code.

### Step 1207

This step corresponds to step 902 in FIG. 9. In some embodiments, the first wireless device 301a is enabled to be discoverable by the second wireless device 301b by sending 902a request for discovery towards the ProSe NW Function 308 in the network node 305. The request is a request to discover a user y 315y which also uses the application 302 but in another wireless device. The request comprises a ProSe ID identifying a first ProSe Function 303a in the first wireless device 301a and the Application User ID to be discovered.

### Step 1208

This step corresponds to step 904 in FIG. 9. In some embodiments, the first wireless device 301a is enabled to be discoverable by the second wireless device 301b by receiving, from the ProSe NW Function 308 in the network node 305 the expression code for the user y 315y for monitoring.

### Step 1209

This step corresponds to step 905 in FIG. 9 and step 1002 in FIG. 10. In some embodiments, the first wireless device 301a is enabled to discover the second wireless device 301b by monitoring the expression code for the second wireless device 301b.

### Step 1210

This step corresponds to step 1002 in FIG. 10. In some embodiments, the first wireless device 301a is enabled to discover the second wireless device 301b by detecting the monitored expression code.

### Step 1211

This step corresponds to step 1002 in FIG. 10. In some embodiments, the first wireless device 301a is enabled to discover the second wireless device 301b by translating the detected expression code to the Application User ID.

### Step 1212

This step corresponds to step 1003 and step 1004 in FIG. 10. In some embodiments, the first wireless device 301a is enabled to discover the second wireless device 301b by, based on the Application User ID, detecting that the second wireless device 301b is in proximity of the first wireless device 301a.

### Step 1213

The first wireless device 301a communicates directly with the second wireless device 301b using the direct ProSe link 304.

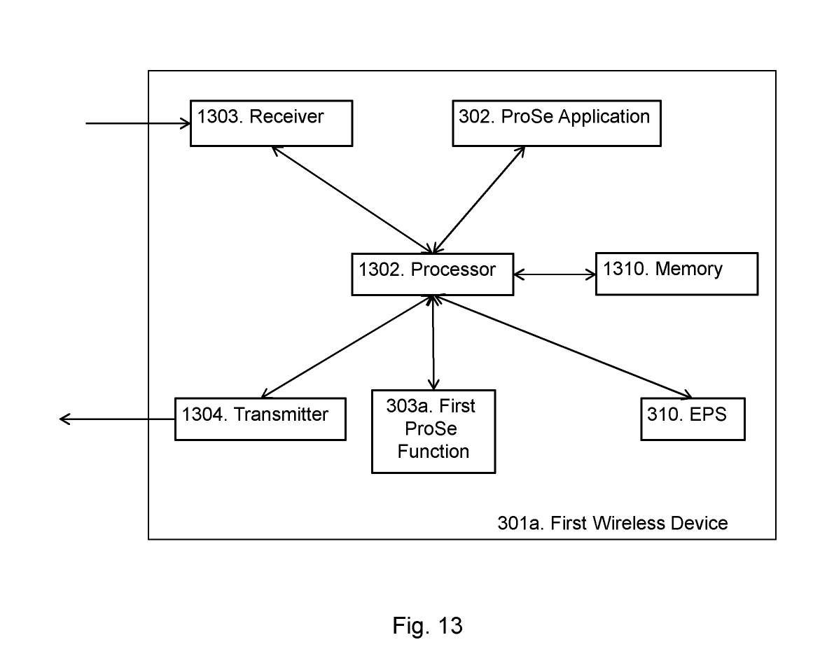

To perform the method steps shown in FIG. 6-12 for enabling ProSe communication in the communication system 300 the first wireless device 301a may comprise an arrangement as shown in FIG. 13. The arrangement shown in FIG. 13 may apply to any of the first wireless device 301a and second wireless device 301b.

As mentioned above, the first wireless device 301a comprises at least one ProSe Application 302 configured to be used by a user x 315x, a first ProSe function 303a and an EPS 310. The ProSe application 302 in the first wireless device 301a may be configured to request a first ProSe function 303a in the first wireless device 301a to be discoverable by other wireless devices.

The first wireless device 301a is configured to, e.g. by means of a discovering module (not shown), using at least one of an Application ID, ProSe ID, Application User ID and expression code, enable the first wireless device 301a to discover the second wireless device 301b and to be discoverable by the second wireless device 301b. As mentioned above, the expression code may be an identity which the first wireless device 301a uses for broadcasting its identity when it is ProSe enabled and the Application ID may identify an application 302 running in the first wireless device 301a or the second wireless device. The Application User ID may be an ID used by an application 302 to identify an application user which is ProSe enabled and the ProSe ID may identify a first ProSe Function 303a located in the first wireless device 301a. The ProSe ID may be allocated to a subscriber of a ProSe enabled first wireless device 301a. In some embodiments, the Application ID is a ProSe Application ID, the ProSe ID is a ProSe User ID, the Application User ID is an Application Layer User ID and the expression code is an announcing code. The discovering module 1301 may be a processor 1302 of the first wireless device 301a.

The first wireless device 301a is configured to, e.g. by means of a receiver 1303 and a transmitter 1304, communicate directly with the second wireless device 301b using a direct ProSe link 304. The receiver 1303 may also be referred to as a receiving unit, a receiving module, a receiving means, a receiving circuit, means for receiving or an input unit. The receiver 1303 may be a wireless transmitter of the first wireless device 301a of a wireless or fixed communications system. The transmitter 1304 may also be referred to as a transmitting unit, a transmitting module, a transmitting means, a transmitting circuit, means for transmitting or an output unit. The transmitter 1304 may be a wireless transmitter of the first wireless device 301a of a wireless or fixed communications system.

In some embodiments, the first wireless device 301a is enabled to be discoverable by the second wireless device 301b by being configured to send, e.g. by means of the receiver 1303, to a ProSe NW Function 308 in the network node 305, a request for being discoverable. The first ProSe Function 303a in the first wireless device 301a may identify itself with a ProSe ID in the request.

In some embodiments, the first wireless device 301a is enabled to be discoverable by the second wireless device 301b by being configured to receive, e.g. by means of the receiver 1303, from the ProSe NW Function 308 in the network node 305, the expression code for the first wireless device 301a for being discoverable.

In some embodiments, the first wireless device 301a is enabled to be discoverable by the second wireless device 301b by being configured to, e.g. by means of the transmitter 1304, broadcast the expression code.

In some embodiments, the first wireless device 301a is enabled to discover the second wireless device 301b by being configured to monitor, e.g. by means of a monitoring module (not shown), an expression code for the second wireless device 301b. The monitoring module may also be referred to as a monitoring unit, a monitoring means, a monitoring circuit, means for monitoring etc. The monitoring module may be the processor 1302 of the first wireless device 301a.

In some embodiments, the first wireless device 301a is enabled to discover the second wireless device 301b by being configured to detect, e.g. by means of a detecting module (not shown), the monitored expression code. The detecting module may also be referred to as a detecting unit, a detecting means, a detecting circuit, means for detecting etc. The detecting module may be the processor 1302 of the first wireless device 301a.

In some embodiments, the first wireless device 301a is enabled to discover the second wireless device 301b by being configured to translate, e.g. by means of a translating module (not shown), the detected expression code to the Application User ID. The translating module may also be referred to as a translating unit, a translating means, a translating circuit, means for translating etc. The translating module may be the processor 1302 of the first wireless device 301a.

In some embodiments, the first wireless device 301a is enabled to discover the second wireless device 301b by being configured to, based on the Application User ID, detect, e.g. by means of the detecting module, that the second wireless device 301b is in proximity of the first wireless device 301a.

In some embodiments, the first wireless device 301a is enabled to be discoverable by the second wireless device 301b by being configured to send, e.g. by means of the transmitter 1304, a request for discovery towards the ProSe NW Function 308 in the network node 305. The request is a request to discover a user y 315y which also uses the application 302 but in another wireless device. The request comprises a ProSe ID identifying a first ProSe Function 303a in the first wireless device 301a and the Application User ID to be discovered.

In some embodiments, the first wireless device 301a is enabled to be discoverable by the 35 second wireless device 301b by being configured to receive, e.g. by means of the receiver 1303, from the ProSe NW Function 308 in the network node 305 the expression code for the user y 315y for monitoring.

In some embodiments, the first wireless device 301a is enabled to be discoverable by the second wireless device 301b by being configured to transmit, e.g. by means of the transmitter 1304, towards the ProSe NW Function 308 in the network node 305, a request for authorization of an application 302 in the first wireless device 301a to use ProSe.

In some embodiments, the first wireless device 301a configured to, e.g. by means of the transmitter 1304, send a request for application registration towards the ProSe NW Function 308 in the network node 305. The first wireless device 301a identifies itself by the ProSe ID and the Application User ID.

Furthermore, the first wireless device 301a is configured to, e.g. by means of the receiver 1302, receive data from e.g. another wireless device 301 or from the network node 305.

The first wireless device 301a is configured to, e.g. by means of the transmitter 1303, transmit data to e.g. another wireless device or to the network node 305.

The first wireless device 301a may further comprise a memory 1310 comprising one or more memory units. The memory 1310 is arranged to be used to store data, received data streams, power level measurements, ProSe identities, threshold values, time periods, configurations, schedulings, and applications to perform the methods herein when being executed in the first wireless device 301a.

The embodiments herein for enabling ProSe communication may be implemented through one or more processors, such as the processor 1302 in the first wireless device 301a depicted in FIG. 13, together with computer program code for performing the functions and actions of the embodiments herein. The program code mentioned above may also be provided as a computer program product, for instance in the form of a data carrier carrying computer program code for performing the embodiments herein when being loaded into the in the first wireless device 301a. One such carrier may be in the form of a CD ROM disc. It is however feasible with other data carriers such as a memory stick. The computer program code may furthermore be provided as pure program code on a server and downloaded to the first wireless device 301a.

Those skilled in the art will also appreciate that the ProSe Application 302, the first ProSe Function 303a, the EPS 310, the receiver 1303 and the transmitter 1304 described above may refer to a combination of analog and digital circuits, and/or one or more processors configured with software and/or firmware, e.g. stored in a memory, that when executed by the one or more processors such as the processor 1302 perform as described above.

A computer program may comprise instructions which, when executed on at least one processor, cause the at least one processor, e.g. the processor 1302, to carry out at least one of the steps described in relation to the method in FIGS. 5-12. A carrier may comprise the computer program, and the carrier is one of an electronic signal, optical signal, radio signal or computer readable storage medium, e.g. the memory 1310.

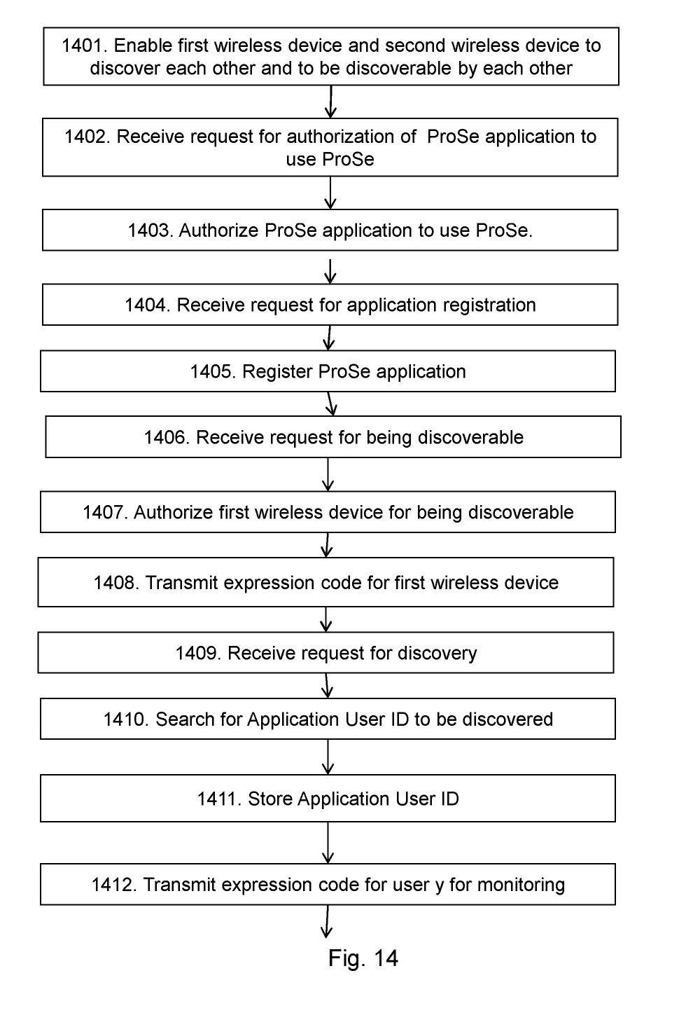

The method described above will now be described seen from the perspective of the network node 305. FIG. 14 is a flowchart describing the present method in the network node 305 for enabling ProSe communication in the communications network 300. The network node 305 may comprise the ProSe NW function 308. The method comprises the further steps to be performed by the network node 305:

### Step 1401

Using at least one of an Application ID, ProSe ID, Application User ID and expression code, the network node 305 enables the first wireless device 301a and the second wireless device 301b to discover each other and to be discoverable by each other.

The first wireless device 301a may comprise a ProSe application 302 used by a user x 315x.

The expression code may be an identity which the ProSe enabled first wireless device 301a uses for broadcasting its identity and the Application ID may be an ID identifying a ProSe application 302 running in the first wireless device 301a or the second wireless device 301b. The Application User ID may be an ID used by the ProSe application 302 to identify an application user which is ProSe enabled and the ProSe ID may identify a first ProSe Function 303a located in the first wireless device 301a. The ProSe ID may be allocated to a subscriber of a ProSe enabled first wireless device 301a.

In some embodiments, the Application ID is a ProSe Application ID, the ProSe ID is a ProSe User ID, the Application User ID is an Application Layer User ID and the expression code is an announcing code.

### Step 1402

This step corresponds to step 602 in FIG. 6 and step 1101 in FIG. 11. In some embodiments, the network node 305 receives, from the first wireless device 301a, a request for authorization of a ProSe application 302 in the first wireless device 301a to use ProSe.

### Step 1403

This step corresponds to step 603 in FIG. 6. In some embodiments, the network node 305 authorizes the ProSe application 302 to use ProSe.

### Step 1404

This step corresponds to step 802 in FIG. 8. In some embodiments, the network node 305 receives a request for application registration from the first wireless device 301a. The first wireless device 301a identifies itself by the ProSe ID and the Application User ID.

### Step 1405

This step corresponds to step 803 in FIG. 8. In some embodiments, the network node 305 registers the ProSe application 302 by storing the Application User ID for the ProSe ID.

### Step 1406

This step corresponds to step 701 in FIG. 7. In some embodiments, the network node 305 enables the first wireless device 301a and the second wireless device 301b to be discoverable by each other by that the network node 305 receives, by the ProSe NW Function 308 and from the first wireless device 301a, a request for being discoverable. A first ProSe Function 303a in the first wireless device 301a identifies itself with a ProSe ID in the request.

### Step 1407

This step corresponds to step 702 in FIG. 7. In some embodiments, the network node 305 enables the first wireless device 301a and the second wireless device 301b to be discoverable by each other by that the network node 305 authorizes the first wireless device 301a for being discoverable.

### Step 1408

This step corresponds to step 703 in FIG. 7. In some embodiments, the network node 305 enables the first wireless device 301a and the second wireless device 301b to be discoverable by each other by that the network node 305 transmits, to the first wireless device 301a, the expression code for the first wireless device 301a.

### Step 1409

This step corresponds to step 902 in FIG. 9. In some embodiments, the first wireless device 301a and the second wireless device 301b are enabled to be discoverable by each other by that the network node 305 receives a request for discovery from the first wireless device 301a. The request is a request to discover a user y 315y which also uses the ProSe application 302 but in another wireless device. The request comprises a ProSe ID identifying a first ProSe Function 303a in the first wireless device 301a and the Application User ID to be discovered.

### Step 1410

This step corresponds to step 903 in FIG. 9. In some embodiments, the first wireless device 301a and the second wireless device 301b are enabled to be discoverable by each other by that the network node 305 searches for the Application User ID to be discovered.

### Step 1411

This step corresponds to step 903 in FIG. 9. In some embodiments, the first wireless device 301a and the second wireless device 301b are enabled to be discoverable by each other by that the network node 305 stores the Application User ID in a ProSe record for the user y 315y if the network node 305 has registered the Application User ID.

### Step 1412

This step corresponds to step 904 in FIG. 9. In some embodiments, the first wireless device 301a and the second wireless device 301b are enabled to be discoverable by each other by that the network node 305 transmits the expression code for the user y 315y to the requesting first wireless device 301a for monitoring.

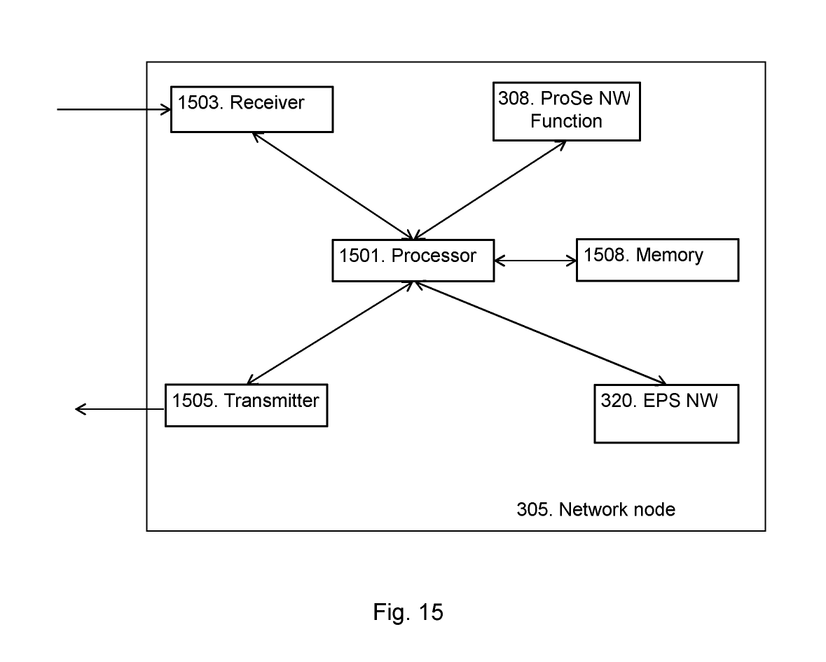

To perform the method steps shown in FIGS. 6-11 and 14 for configuring enabling ProSe communication in the communication system 300 the network node 305 may comprise an arrangement as shown in FIG. 15. Using only the reference number 305 indicates that the arrangement shown in FIG. 15 may apply to any of the first network node 305a and the second network node 305b seen in FIG. 9, the network node 305 seen in FIGS. 3-8 or to any kind of network node such as e.g. MME, SGW, PGW, PCRF, HSS, HLR etc.

As mentioned above, the network node 305 comprises at least one ProSe NW Function 308 and an EPS NW 320.

The network node 305 is configured to, e.g. by means of an enabling module (not shown), using at least one of an Application ID, ProSe ID, Application User ID and expression code, enable a first wireless device 301a and a second wireless device 301b to discover each other and to be discoverable by each other. The expression code may be an identity which the ProSe enabled first wireless device 301a uses for broadcasting its identity and the Application ID may be an ID identifying a ProSe application 302 running in the first wireless device 301a or the second wireless device 301b. The Application User ID may be an ID used by the ProSe application 302 to identify an application user which is ProSe enabled and the ProSe ID may identify a first ProSe Function 303a located in the first wireless device 301a. The ProSe ID may be allocated to a subscriber of a ProSe enabled first wireless device 301a. In some embodiments, the Application ID is a ProSe Application ID, the ProSe ID is a ProSe User ID, the Application User ID is an Application Layer User ID and the expression code is an announcing code. The enabling module may be a processor 1501 of the network node 305. The enabling module may also be referred to as a enabling unit, a enabling means, a enabling circuit, means for enabling or etc.

In some embodiments, the network node 305 is configured to enable the first wireless device 301a and the second wireless device 301b to be discoverable by each other by being further configured to, e.g. by means of a receiver 1503, receive, at the ProSe NW Function 308 and from the first wireless device 301a, a request for being discoverable. A first ProSe Function 303a in the first wireless device 301a may identify itself with a ProSe ID in the request. The receiver 1503 may also be referred to as a receiving unit, a receiving module, a receiving means, a receiving circuit, means for receiving, input unit etc. The receiver 1503 may be a wireless receiver of the network node 305 of a wireless or fixed communications system.

In some embodiments, the network node 305 is configured to enable the first wireless device 301a and the second wireless device 301b to be discoverable by each other by being further configured to, e.g. by means of an authorizing module (not shown), authorize the first wireless device 301a for being discoverable. The authorizing module may be the processor 1501 of the network node 305. The authorizing module may also be referred to as a authorizing unit, a authorizing means, a authorizing circuit, means for authorizing or etc.

In some embodiments, the network node 305 is configured to enable the first wireless device 301a and the second wireless device 301b to be discoverable by each other by being further configured to, e.g. by means of a transmitter 1505, transmit, to the first wireless device 301a, the expression code for the first wireless device 301a. The transmitter 1505 may also be referred to as a transmitting unit, a transmitting module, a transmitting means, a transmitting circuit, means for transmitting, output unit etc. The transmitter 1505 may be a wireless transmitter of the network node 305 of a wireless or fixed communications system.

In some embodiments, the first wireless device 301a and the second wireless device 301b are enabled to be discoverable by each other by that the network node 305 is configured to, e.g. by means of the receiver 1503, receive a request for discovery from the first wireless device 301a. The request is a request to discover a user y 315y which also uses the ProSe application 302 but in another wireless device. The request comprises a ProSe ID identifying a first ProSe Function 303a in the first wireless device 301a and the Application User ID to be discovered.

In some embodiments, the first wireless device 301a and the second wireless device 301b are enabled to be discoverable by each other by that the network node 305 is configured to, e.g. by means of a searching module (not shown), search for the Application User ID to be discovered. The searching module may be the processor 1501 of the network node 305. The searching module may also be referred to as a searching unit, a searching means, a searching circuit, means for searching or etc.

In some embodiments, the first wireless device 301a and the second wireless device 301b are enabled to be discoverable by each other by that the network node 305 is configured to, e.g. by means of a storing module (not shown), store the Application User ID in a ProSe record for the user y 315y if the network node 305 has registered the Application User ID. The storing module may be the processor 1501 of the network node 305. The storing module may also be referred to as a storing unit, a storing means, a storing circuit, means for storing or etc.

In some embodiments, the first wireless device 301a and the second wireless device 301b are enabled to be discoverable by each other by that the network node 305 is configured to, e.g. by means of the transmitter 1505, transmit the expression code for the user y 315y to the requesting first wireless device 301a for monitoring.

In some embodiments, the network node 305 is configured to, e.g. by means of the receiver 1503, receive, from the first wireless device 301a, a request for authorization of a ProSe application 302 in the first wireless device 301a to use ProSe.

In some embodiments, the network node 305 is configured to, e.g. by means of the receiver 1503, receive a request for application registration from the first wireless device 301a. The first wireless device 301a may identify itself by the ProSe ID and the Application User ID.

In some embodiments, the network node 305 is configured to, e.g. by means of a registration module (not shown), register the ProSe application 302 by storing the Application User ID for the ProSe ID. The registration module may be the processor 1501 of the network node 305. The registration module may also be referred to as a registration unit, a registration means, a registration circuit, means for registration or etc.

In some embodiments, the network node 305 is configured to, e.g. by means of the authorizing module, authorize the ProSe application 302 to use ProSe.

Furthermore, the network node 305 may comprise the receiver 1503 adapted to receive data from e.g. a wireless device 301 or from another network node 305.

The network node 305 may comprise the transmitter 1505 which is adapted to transmit data to e.g. a wireless device 301 or to another the network node 305.

The network node 305 may further comprise a memory 1508 comprising one or more memory units. The memory 1508 is arranged to be used to store data, received data streams, power level measurements, ProSe identities, threshold values, time periods, configurations, schedulings, and applications to perform the methods herein when being executed in the network node 305.

The embodiments herein for enabling ProSe communication may be implemented through one or more processors, such the processor 1501 in the network node 305 depicted in FIG. 15, together with computer program code for performing the functions and actions of the embodiments herein. The program code mentioned above may also be provided as a computer program product, for instance in the form of a data carrier carrying computer program code for performing the embodiments herein when being loaded into the network node 305. One such carrier may be in the form of a CD ROM disc. It is however feasible with other data carriers such as a memory stick. The computer program code may furthermore be provided as pure program code on a server and downloaded to the network node 305.

Those skilled in the art will also appreciate that the the ProSe NW Function 308, the EPS NW 315, the receiver 1503 and the transmitter 1505 described above may refer to a combination of analog and digital circuits, and/or one or more processors configured with software and/or firmware, e.g. stored in a memory, that when executed by the one or more processors such as the processor 1501 perform as described above.

A computer program may comprise instructions which, when executed on at least one processor, cause the at least one processor, e.g. the processor 1501, to carry out at least one of the steps described in relation to the method in FIGS. 5-11 and 14. A carrier may comprise the computer program, and the carrier is one of an electronic signal, optical signal, radio signal or computer readable storage medium, e.g. the memory 1508.

The embodiments herein are not limited to the above described embodiments. Various alternatives, modifications and equivalents may be used. Therefore, the above embodiments should not be taken as limiting the scope of the embodiments.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements. The term “configured to” used herein may also be referred to as “arranged to” or “adapted to” or “operable to”.

It should also be emphasized that the steps of the methods defined in the appended claims may, without departing from the embodiments herein, be performed in another order than the order in which they appear.

1. A method in a first wireless device for enabling Proximity Service, ProSe, communication in a communications network, the first wireless device being in proximity of a second wireless device, the method comprising:
using at least one of an Application ID, ProSe ID, Application User ID and expression code, enabling the first wireless device to discover the second wireless device and to be discoverable by the second wireless device; and
communicating with the second wireless device using a direct ProSe link.

2. The method according to claim 1, wherein the first wireless device is enabled to be discoverable by the second wireless device by:
sending, to a ProSe NetWork, NW, function in a network node, a request for being discoverable, wherein a first ProSe Function in the first wireless device identifies itself with a ProSe ID in the request;
receiving, from the ProSe NW function in the network node, the expression code for the first wireless device for being discoverable; and
broadcasting the expression code.

3. The method according to claim 1, wherein the first wireless device is enabled to discover the second wireless device by:
monitoring the expression code for the second wireless device;
detecting the monitored expression code;
translating the detected expression code to the Application User ID; and
based on the Application User ID, detecting that the second wireless device is in proximity of the first wireless device.

4. The method according to claim 1, wherein the first wireless device comprises a ProSe application used by a user x, and wherein the first wireless device is enabled to be discoverable by the second wireless device by:
sending a request for discovery towards a ProSe NetWork, NW, function in the network node, wherein the request is a request to discover a user y which also uses the ProSe application but in another wireless device, and wherein the request comprises a ProSe ID identifying a first ProSe Function in the first wireless device and the Application User ID to be discovered; and
receiving, from the ProSe NW function in the network node the expression code for the user y for monitoring.

5. The method according to claim 1, wherein a ProSe application in the first wireless device requests a first ProSe function in the first wireless device to be discoverable by other wireless devices.

6. The method according to claim 1, further comprising:
transmitting, towards a ProSe NetWork, NW, function in the network node, a request for authorization of a ProSe application in the first wireless device to use ProSe.

7. The method according to claim 1, further comprising:
sending a request for application registration towards a ProSe NetWork, NW, function in the network node, wherein the first wireless device identifies itself by the ProSe ID and the Application User ID.

8. The method according to claim 1, wherein:
the expression code is an identity which the first wireless device uses for broadcasting its identity when it is ProSe enabled
the Application ID identifies a ProSe application running in the first wireless device or the second wireless device;
the Application User ID is an ID used by a ProSe application to identify an application user which is ProSe enabled;
the ProSe ID identifies a first ProSe Function located in the first wireless device; and
the ProSe ID is allocated to a subscriber of a ProSe enabled first wireless device.

9. The method according to claim 1, wherein the Application ID is a ProSe Application ID, the ProSe ID is a ProSe User ID, the Application User ID is an Application Layer User ID and the expression code is an announcing code.

10. A method in a network node for enabling Proximity Service, ProSe, communication in a communications network, the method comprising:
using at least one of an Application ID, ProSe ID, Application User ID and expression code, enabling a first wireless device and a second wireless device to discover each other and to be discoverable by each other.

11. The method according to claim 10, wherein the network node comprises a ProSe NetWork, NW, function and wherein the network node enables the first wireless device and the second wireless device to be discoverable by each other by:
receiving, by the ProSe NW function and from the first wireless device, a request for being discoverable, wherein a first ProSe Function in the first wireless device identifies itself with a ProSe ID in the request;
authorizing the first wireless device for being discoverable; and
transmitting, to the first wireless device, the expression code for the first wireless device.

12. The method according to claim 10, wherein the first wireless device comprises a ProSe application used by a user x, and wherein the first wireless device and the second wireless device are enabled to be discoverable by each other by:
receiving a request for discovery from the first wireless device, wherein the request is a request to discover a user y which also uses the ProSe application but in another wireless device, and wherein the request comprises a ProSe ID identifying a first ProSe Function in the first wireless device and the Application User ID to be discovered;
searching for the Application User ID to be discovered;
storing the Application User ID in a ProSe record for the user y if the network node has registered the Application User ID; and
transmitting the expression code for the user y to the requesting first wireless device for monitoring.

13. The method according to claim 10, further comprising:
receiving, from the first wireless device, a request for authorization of a ProSe application in the first wireless device to use ProSe; and
authorizing the ProSe application to use ProSe.

14. The method according to claim 10, further comprising:
receiving a request for application registration from the first wireless device, wherein the first wireless device identifies itself by the ProSe ID and the Application User ID; and
registering the ProSe application by storing the Application User ID for the ProSe ID.

15. The method according to claim 10, wherein:
the expression code is an identity which the ProSe enabled first wireless device uses for broadcasting its identity;
the Application ID is an ID identifying a ProSe application running in the first wireless device or the second wireless device;
the Application User ID is an ID used by the Pro Se application to identify an application user which is ProSe enabled;
the ProSe ID identifies a first ProSe Function located in the first wireless device; and
the ProSe ID is allocated to a subscriber of a ProSe enabled first wireless device.

16. The method according to claim 10, wherein the Application ID is a ProSe Application ID, the ProSe ID is a ProSe User ID, the Application User ID is an Application Layer User ID and the expression code is an announcing code.

17. A first wireless device for enabling Proximity Service, ProSe, communication in a communications network, the first wireless device being in proximity of a second wireless device, the first wireless device being configured to:
using at least one of an Application ID, ProSe ID, Application User ID and expression code, enable the first wireless device to discover the second wireless device and to be discoverable by the second wireless device; and
communicate directly with the second wireless device using a direct ProSe link.

18. The first wireless device according to claim 17, wherein the first wireless device is enabled to be discoverable by the second wireless device by being configured to:
send, to a ProSe NetWork, NW, function in a network node, a request for being discoverable, wherein a first ProSe Function in the first wireless device identifies itself with a ProSe ID in the request;
receive, from the ProSe NW function in the network node, the expression code for the first wireless device for being discoverable; and
broadcast the expression code.

19. The first wireless device according to claim 17, wherein the first wireless device is enabled to discover the second wireless device by being configured to:
monitor an expression code for the second wireless device;
detect the monitored expression code;
translate the detected expression code to the Application User ID; and
based on the Application User ID, detect that the second wireless device is in proximity of the first wireless device.

20. The first wireless device according to claim 17, wherein the first wireless device comprises a ProSe application used by a user x, and wherein the first wireless device is enabled to be discoverable by the second wireless device by being configured to:
send a request for discovery towards a ProSe NetWork, NW, function in the network node, wherein the request is a request to discover a user y which also uses the ProSe application but in another wireless device, and wherein the request comprises a ProSe ID identifying a first ProSe Function in the first wireless device and the Application User ID to be discovered; and
receive, from the ProSe NW function in the network node the expression code for the user y for monitoring.

21. The first wireless device according to claim 17, wherein a ProSe application in the first wireless device is configured to request a first ProSe function in the first wireless device to be discoverable by other wireless devices.

22. The first wireless device according to claim 17, being further configured to:
transmit, towards a ProSe NetWork, NW, function in the network node, a request for authorization of a ProSe application in the first wireless device to use ProSe.

23. The first wireless device according to claim 17, being further configured to:
send a request for application registration towards a ProSe NetWork, NW, function in the network node, wherein the first wireless device identifies itself by the ProSe ID and the Application User ID.

24. The first wireless device according to claim 17, wherein:
the expression code is an identity which the first wireless device uses for broadcasting its identity when it is ProSe enabled;
the Application ID identifies a ProSe application running in the first wireless device or the second wireless device;
the Application User ID is an ID used by the ProSe application to identify an application user which is ProSe enabled;
the ProSe ID identifies a first ProSe Function located in the first wireless device; and
the ProSe ID is allocated to a subscriber of a ProSe enabled first wireless device.

25. The first wireless device according to claim 17, wherein the Application ID is a ProSe Application ID, the ProSe ID is a ProSe User ID, the Application User ID is an Application Layer User ID and the expression code is an announcing code.

26. A network node for enabling Proximity Service, ProSe, communication in a communications network, the network node being configured to:
using at least one of an Application ID, ProSe ID, Application User ID and expression code, enable a first wireless device and a second wireless device to discover each other and to be discoverable by each other.

27. The network node according to claim 26, wherein the network node comprises a ProSe NetWork, NW, function and wherein the network node is configured to enable the first wireless device and the second wireless device to be discoverable by each other by being configured to:
receive, by the ProSe NW function and from the first wireless device a request for being discoverable, wherein a first ProSe Function in the first wireless device identifies itself with a ProSe ID in the request;
authorize the first wireless device for being discoverable; and
transmit, to the first wireless device, the expression code for the first wireless device.

28. The network node according to claim 26, wherein the first wireless device comprises a ProSe application used by a user x, and wherein the first wireless device and the second wireless device are enabled to be discoverable by each other by that the network node is configured to:
receive a request for discovery from the first wireless device, wherein the request is a request to discover a user y which also uses the ProSe application but in another wireless device, and wherein the request comprises a ProSe ID identifying a first ProSe Function in the first wireless device and the Application User ID to be discovered;
search for the Application User ID to be discovered;
store the Application User ID in a ProSe record for the user y if the network node has registered the Application User ID; and
transmit the expression code for the user y to the requesting first wireless device for monitoring.

29. The network node according to claim 26, being further configured to:
receive, from the first wireless device, a request for authorization of a ProSe application in the first wireless device to use ProSe; and
authorize the ProSe application to use ProSe.

30. The network node according to claim 26, being further configured to:
receive a request for application registration from the first wireless device, wherein the first wireless device identifies itself by the ProSe ID and the Application User ID; and
register the ProSe application by storing the Application User ID for the ProSe ID.

31. The network node according to claim 26, wherein:
the expression code is an identity which the ProSe enabled first wireless device uses for broadcasting its identity;
the Application ID is an ID identifying a ProSe application running in the first wireless device or the second wireless device;
the Application User ID is an ID used by the ProSe application to identify an application user which is ProSe enabled;
the ProSe ID identifies a first ProSe Function located in the first wireless device; and
the ProSe ID is allocated to a subscriber of a ProSe enabled first wireless device.

32. The network node according to claim 26, wherein the Application ID is a ProSe Application ID, the ProSe ID is a ProSe User ID, the Application User ID is an Application Layer User ID and the expression code is an announcing code.

33. A computer readable storage medium storing a computer program comprising instructions which, when executed on at least one processor, cause the at least one processor to carry out a method in a first wireless device for enabling Proximity Service, ProSe, communication in a communications network, the first wireless device being in proximity of a second wireless device, the method comprising:
using at least one of an Application ID, ProSe ID, Application User ID and expression code, enabling the first wireless device to discover the second wireless device and to be discoverable by the second wireless device; and
communicating with the second wireless device using a direct ProSe link.

34. (canceled)

35. A computer readable storage medium storing a computer program comprising instructions which, when executed on at least one processor, cause the at least one processor to carry out a method 16 in a network node for enabling Proximity Service, ProSe, communication in a communications network, the method comprising:
using at least one of an Application ID, ProSe ID, Application User ID and expression code, enabling a first wireless device and a second wireless device to discover each other and to be discoverable by each other.

36. (canceled)
